(19) United States
(12) Patent Application Publication
(10) Pub. No.: US 2005/0199344 A1
(43) Pub. Date: Sep. 15, 2005

(54) Label feeder

(76) Inventor: Kent Lord, Brantevik (SE)

Correspondence Address: Breiner & Breiner, L.L.C., P.O. Box 19290, Alexandria, VA, 22320-0290, US

(21) Appl. No.: 11/070,257

(22) Filed: Mar. 3, 2005

Related U.S. Application Data
(63) Continuation-in-part of application No. 09/744,943, filed on Mar. 13, 2001, now abandoned.

(30) Foreign Application Priority Data
Aug. 4, 1998 (SE) 9802664-4
Jul. 19, 1999 (WO) PCT/SE99/01288

(51) Int. Cl. G05G 15/00; B32B 31/00

(52) U.S. Cl. 156/351

(57) ABSTRACT

A label feeder which applies labels with electromagnetic wave information thereon to a linerless label material or liner label material having graphic information thereon is disclosed. The label feeder provides information to and retrieves information from the labels with electromagnetic wave information before the graphic label is applied on the product. The linerless label material or liner label material can be covered with adhesive on one side and with a low adhesion substrate on the other side or be partly covered on both sides, both longitudinally or transversely. By using a label feeder using a label material, it is possible to print graphic information on an even label material, application of a label with electromagnetic wave information providing or receiving information, and inline control before application. A method for making labels is also disclosed.

### RELATED APPLICATION

This application is a continuation-in-part of U.S. Ser. No. 09/744,943 filed Mar. 13, 2001 entitled “LABEL FEEDER”.

### FIELD OF INVENTION

The present invention relates to a label feeder in which labels with electromagnetic wave information thereon are applied on a linerless label material or a liner label material.

### BACKGROUND OF THE INVENTION

When self-adhesive labels with electromagnetic wave information today are applied, the most common method is first to apply a label with electromagnetic wave information and then a graphic label on top thereof. The reason for positioning a graphic label, for example, a price label, usually on top thereof is for concealing the label with electromagnetical wave information, for example, an alarm. A currently used technique is that at label manufacture, before the labels are stamped out of their carrier web, the combined, self-adhesive label front material web is removed from its carrier web, usually silicon paper, whereupon the label with electromagnetic wave information, for example, a label with a memory circuit and an antenna or a coil/capacitor with an antenna, is applied on the adhesive. The self-adhesive front web is then joined with the carrier web, whereupon the label is stamped out of the front web, so that the label with the electromagnetic wave information is below and concealed. This label can then be applied on the product in an ordinary label dispenser. In this case, thermo printing or thermo transfer printing is a problem since thermo printing requires a plane surface, and with a label with electromagnetic wave information below, the surface is uneven.

Another technique is to apply the label with electromagnetic wave information in a laminate between two material layers, which gives the same problem as described above.

Another problem today is that each and every mechanical influence or passing of an undesireable electromagnetic field in certain cases influences the stored information on a label or prevents the label from receiving the desired information. For this reason, the mechanical or electromagnetic field influence should be as small as possible.

The function of a label with electromagnetic wave information is, for example, to receive information via radio waves and store this information in a memory device. This information is then later emitted via radio waves on another occasion. The label may also have a circuit with coil and capacitor, which in a radio wave field emits a wave length of its own, which then can be indicated as an alarm.

### OBJECTS AND SUMMARY OF THE INVENTION

The present invention is a label feeder which applies labels with electromagnetic wave information to a linerless label material or a liner label material having graphic information thereon. The label feeder provides information to and retrieves information from the labels with electromagnetic wave information shortly before the graphic label is applied on the product. The linerless label material or liner label material can be covered with adhesive on one side and with a low adhesion substrate on the other side or be partly covered on both sides, both longitudinally or transversely.

By using a label feeder with liner or linerless label material as carriers and as covering elements, it is possible to print graphic information on an even material web, i.e., the label material, and to apply thereto the labels with electromagnetic wave information thereon in line before the application on a product, whereby a material saving and thus cheaper design is obtained. By using this label feeder, other functions may also be accomplished.

The present invention makes it possible to print graphic material over the entire label surface since the electromagnetic wave information thereon, e.g., alarm tags, chips or the like (which otherwise constitutes an uneven surface), are added after the printing. Further, it is possible to be selective in applying alarm tags, chips or other types of labels with electromagnetic wave information thereon to label material to form individual labels. For example, labels with electromagnetic wave information thereon may be added to the label material such that only a predetermined number of individual labels, for example every second, fifth or tenth individual label, may be provided with a label with electromagnetic wave information thereon. This will aid in keeping costs down and still create unsurity among potential shoplifters since they will not know which individual labels have alarm tags or other labels with electromagnetic wave information thereon.

These objects and other objects of the invention will be apparent from the following description and from the accompanying drawings.

### BRIEF DESCRIPTION OF THE DRAWINGS

Referring to the drawings:

FIG. 1 shows a side view of a first embodiment of a label feeder of the present invention;

FIG. 2 shows a side view of a second embodiment of a label feeder of the present invention;

FIG. 3 shows a side view of a third embodiment of a label feeder of the present invention;

FIG. 4 shows a side view of a fourth embodiment of a label feeder of the present invention;

FIG. 5 shows a side view of a fifth embodiment of a label feeder of the present invention;

FIG. 6 shows a side view of a sixth embodiment of a label feeder of the present invention;

FIG. 7 shows a side view of a seventh embodiment of a label feeder of the present invention;

FIG. 8 shows a side view of an eighth embodiment of a label feeder of the present invention; and

FIG. 9 shows a side view of a ninth embodiment of a label feeder of the present invention.

### DETAILED DESCRIPTION OF THE PREFERRED EMBODIMENTS

The present invention is a label feeder 20 which applies a plurality of labels 26 with electromagnetic wave information thereon to a label material 28, such as a linerless label material 28′ or a liner label material 28″, having graphic information thereon. The label feeder 20 provides information to and retrieves information from the plurality of labels 26 with electromagnetic wave information shortly before the graphic label is applied on the product.

While the labels 26 are described throughout as labels 26 with electromagnetic information thereon, it is to be understood that the labels 26 may be of various label structures, for example more intelligent label types such as labels which carry sophisticated information about the product on which it will be placed, as well as alarm tags or the like.

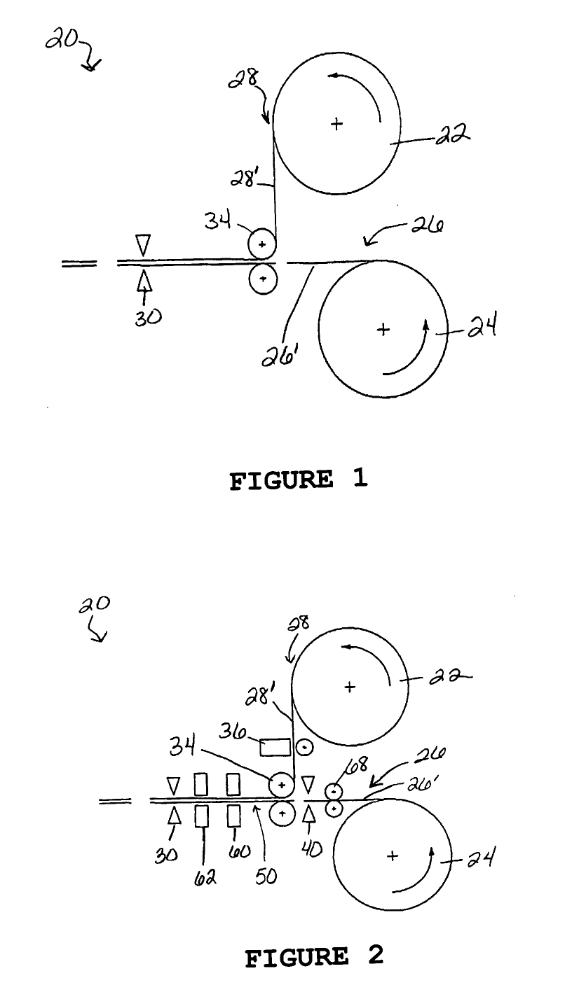

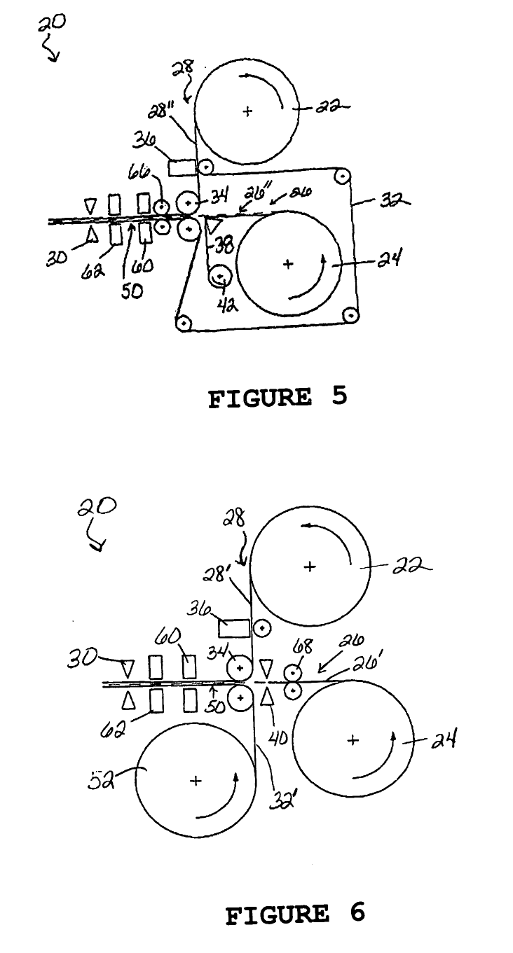

Referring to FIGS. 1-9, the label feeder 20 comprises a first roll 22 having label material 28 thereon, a second roll 24 having a plurality of labels 26, a driven roller means 34 for combining the plurality of labels 26 and the label material 28 together, and a terminal severing or cutting means 30 for making individual labels. The label material 28 on the first roll 22 may be a linerless label material 28′, as shown for example in FIGS. 1-3, 6-9, or a conventional web liner label material 28″, as shown for example in FIGS. 4 and 5.

In a preferred embodiment, the driven roller means 34 preferably has an upper roller and a lower roller. A nip is formed between the upper roller and the lower roller. Either one or both of the rollers may be driven to provide the driven roller means 34.

The linerless label material 28′ is a label material with self-adhesive material on the lower side and with low adhesion material or substrate, such as usually silicon, on the upper side. The linerless label material 28′ can have such self-adhesive and low adhesion substrates over its entire surface or a part thereof. The linerless label material 28′ can also have self-adhesive and/or low adhesion substrates on the lower side and/or the upper side.

The liner label material 28″ is a conventional web label material with an adhesive material such as a self-adhesive material, on the lower side and a liner 32 thereon and with a low adhesion material or substrate, such as silicon, on the upper side. The liner label material 28″ can have adhesive over its entire surface or a part thereof. In an embodiment having liner label material 28″, the liner 32 is preferably separated from the base label material after thermo printing and before the base label material is fed through the driven roller means 34 and combined with the plurality of labels 26 as described in further detail hereafter.

The label material 28 on the first roll 22 passes a printer head 36, which adds graphic information to the label material 28, usually by thermo or thermo transfer printing, before the driven roller means 34 and combining with the label material 28.

In one embodiment, the plurality of labels 26 may be a continuous roll of labels 26′, i.e., continuous label web, which is cut or separated into individual labels by a primary severing or cutting means 40 before being fed through the driven roller means 34 and combined with the label material 28. In another embodiment, the plurality of labels 26 may be individual self-adhesive labels 26″ on a carrier web 38 on the second roll 24. In this embodiment, the individual labels 26″ are separated from the carrier web 38 before being fed through the driven roller means 34 and combined with the label material 28. The empty carrier web 38 is then rolled onto a carrier web roll 42. The plurality of labels 26 are labels with electromagnetic wave information thereon which is usually a memory circuit or a self-oscillating coil/capacitor.

The plurality of labels 26 with electromagnetic wave information thereon are preferably applied on the lower side of the label material 28 by feeding the plurality of labels 26 through the driven roller means 34. The driven roller means 34 makes the plurality of labels 26 with electromagnetic wave information thereon stick to the adhesive on the label material 28 preferably by means of pressure. For example, the label material 28, i.e., a linerless label material 28′ or a liner label material 28″, and the plurality of labels 26 with electromagnetic wave information thereon, i.e., a continuous roll of labels 26′ having labels cut therefrom or individual labels 26″ on a carrier web 38, are combined by the driven roller means 34 to form a combined web material 50.

The driven roller means 34 may also optionally combine the label material 28, the plurality of labels 26 and a liner 32, such as from the liner label material 28″, as shown for example in FIG. 4, or a separate liner 32′, such as from a separate roll 52, as shown for example in FIG. 6, such that the liner 32,32′ is combined to the lower side of the plurality of labels 26 at the driven roller means 34 to form the combined web material 50.

In another embodiment, the liner 32 separated from the label material 28 may be combined with the label material 28 and the plurality of labels 26 in a later step after the label material 28 and plurality of labels 26 are combined by the driven roller means 34. In this embodiment, a drive feeder roller 66 may optionally be positioned after the driven roller means 34 to optionally combine the liner 32 with the already combined label material 28 and plurality of labels 26 to form the combined web material 50.

In another embodiment (not shown), the drive feed roller 66 may alternatively combine a separate liner 32′ to the label material 28 and the plurality of labels 26 after the label material 28 and the plurality of labels 26 are combined to form the combined web material 50 as described above.

The combined web material 50 then preferably passes a programming station 60, where the plurality of labels 26 with electromagnetic wave information thereon receive additional information, such as for example by radio waves. This information is preferably then stored.

Further, the combined web material 50 preferably passes a control station 62 which controls the functioning of the plurality of labels 26 with electromagnetic wave information thereon. For example, the control station 62 controls the radio waves added by the programming station 60 so that the plurality of labels 26 with electromagnetic wave information function properly.

The combined web material 50 finally passes a terminal severing or cutting equipment 30, which cuts the combined web material 50 into suitable lengths of electromagnetic wave information-containing labels/graphic labels.

The various embodiments of the plurality of labels 26, label material 28 and optional liner 32,32′ may be used in conjunction to provide various embodiments of the label feeder 20 of the present invention. For example, some of these embodiments are as follows.

As shown for example in FIGS. 2 and 8, a linerless label material 28′ on the first roll 22 passes a thermo printer head 36 which adds graphic information to the linerless label material 28′. The linerless label material 28′ preferably has an adhesive at least on its lower side. A continuous roll of labels 26′ on the second roll 24 is fed through driven feed roller 68 and then cut into individual labels with electromagnetic wave information thereon by a primary severing means 40, as shown for example in FIG. 8 or cut into pieces of labels, as shown for example in FIG. 2. The labels 26′ and label material 28′ are combined by the driven roller means 34 to form a combined web material 50 which then passes a programming station 60 and receives additional information. The combined web material 50 then passes a control station 62 which controls the functioning of the labels 26′ with electromagnetic wave information thereon. The combined web material 50 finally passes a terminal severing means 30 which cuts the combined web material 50 into suitable lengths of electromagnetic wave information-containing labels/graphic labels.

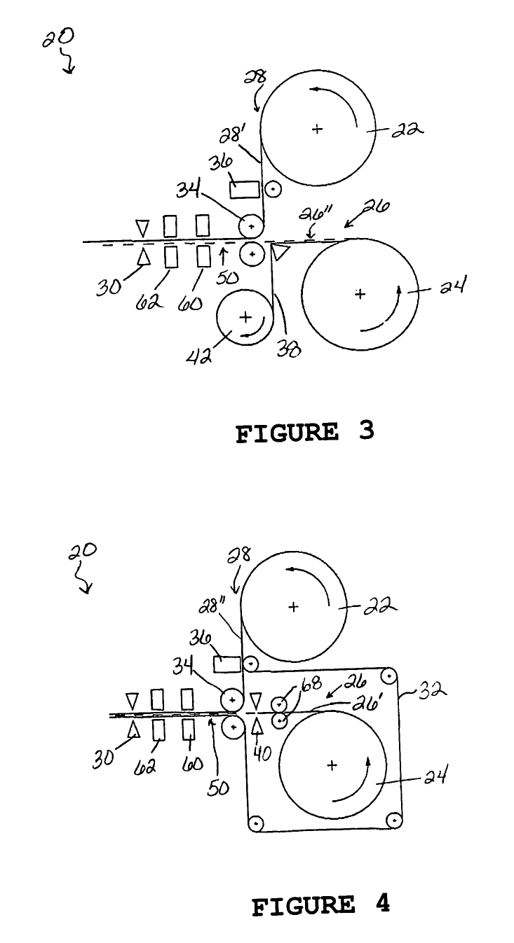

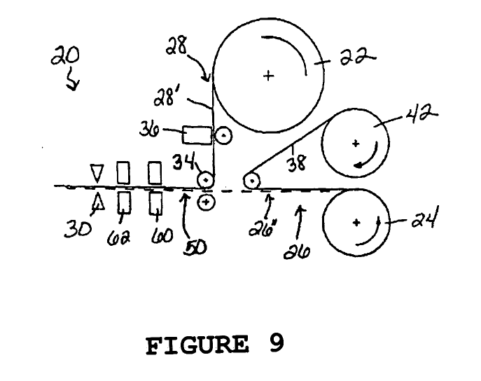

As shown for example in FIGS. 3 and 9, a linerless label material 28′ on the first roll 22 passes a thermo printer head 36 which adds graphic information to the linerless label material 28′. The linerless label material 28′ preferably has an adhesive on at least its lower side. Individual labels 26″ on a carrier web 38 on the second roll 24 are separated from the carrier web 38. The empty carrier web 38 is then rolled onto a carrier web roll 42. The labels 26″ with electromagnetic wave information thereon and the label material 28′ are combined by the driven roller means 34 to form a combined web material 50 which then passes a programming station 60 and receives additional information. The combined web material 50 then passes a control station 62 which controls the functioning of the labels 26″, with electromagnetic wave information thereon. The combined web material 50 finally passes a terminal severing means 30 which cuts the combined web material 50 into suitable lengths of electromagnetic wave information-containing labels/graphic labels.

As shown for example in FIG. 3, the carrier web roll 42 may be positioned such that the carrier web 38 is operatively positioned on a lower side of the labels 26″. As shown for example in FIG. 9, the carrier web roll 42 may be positioned such that the carrier web 38 is operatively positioned on an upper side of the labels 26″.

As shown for example in FIG. 4, a liner label material 28″ on the first roll 22 passes a thermo printer head 36 which adds graphic information to the liner label material 28″. The liner 32 is then preferably separated from the base label material. The base label material preferably has an adhesive at least on its lower side. A continuous roll of labels 26′ with electromagnetic wave information on the second roll 24 is fed through driven feed rollers 68 and then cut into individual labels by a primary severing means 40. Then the liner 32, labels and base label material are combined by the driven roller means 34 to form a combined web material 50 which then passes a programming station 60 and receives additional information. The combined web material 50 then passes a control station 62 which controls the functioning of the labels 26′ with electromagnetic wave information thereon. The combined web material 50 finally passes a terminal severing means 30 which cuts the combined web material 50 into suitable lengths of electromagnetic wave information-containing labels/graphic labels.

In another embodiment (not shown), the individual labels 26″ on a carrier web 38 may be combined with a liner label material 28″ and a liner 32 as described above.

As shown for example in FIG. 5, a liner label material 28″ on the first roll 22 passes a thermo printer head 36 which adds graphic information to the liner label material 28″. The liner 32 is then preferably separated from the base label material. The base label material preferably has an adhesive on at least its lower side. Individual labels 26″ on a carrier web 38 on the second roll 24 are separated from the carrier web 38. The empty carrier web 38 is then rolled onto a carrier web roll 42. The labels 26″, the base label material and the liner 32 are combined by the driven roller means 34 to form a combined web material 50 which then passes a programming station 60 and receives additional information. The combined web material 50 then passes a control station 62 which controls the functioning of the labels 26″ with electromagnetic wave information thereon. The combined web material 50 finally passes a terminal severing means 30 which cuts the combined web material 50 into suitable lengths of electromagnetic wave information-containing labels/graphic labels.

In another embodiment (not shown), the liner 32 may be combined with the combined labels 26″ and the base label material in a step after the labels 26″ and the base label material have already been combined. A driven feed roller 66 may optionally be used to combine the liner 32 with the already combined labels and base material.

In another embodiment (not shown), a roll of continuous labels 26′ cut into individual labels may be combined with the base label material and then combined with the liner 32 in a separate step as described above.

As shown for example in FIG. 6, a linerless label material 28′ on the first roll 22 passes a thermo printer head 36 which adds graphic information to the linerless label material 28′. The linerless label material 28′ preferably has an adhesive on at least its lower side. A continuous roll of labels 26′ on the second roll 24 is fed through driven feed rollers 68 and then cut into individual labels with electromagnetic wave information by a primary severing means 40. The linerless label material 28′, the labels 26′ and a separate liner 32′ from roll 52 are combined by the driven roller means 34 to form a combined web material 50 which then passes a programming station 60 and receives additional information. The combined web material 50 then passes a control station 62 which controls the functioning of the labels 26′ with electromagnetic wave information thereon. The combined web material 50 finally passes a terminal severing means 30 which cuts the combined web material 50 into suitable lengths of electromagnetic wave information-containing labels/graphic labels.

In an alternative embodiment (not shown), the linerless label material 28′ and the labels 26′ may be combined by the driven roller means 34. A separate liner 32′ may then be combined with the already combined linerless label material 28′ and labels 26′ by a driven feeder roller 66 to form a combined web material 50 which then passes a programming station 60, a control station 62 and terminal severing means 30 as described above.

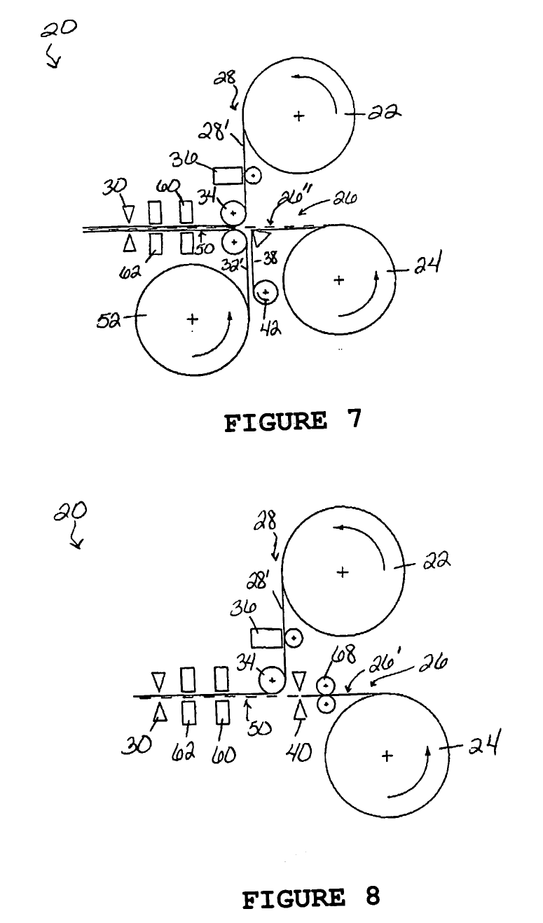

As shown for example in FIG. 7, a linerless label material 28′ on the first roll 22 passes a thermo printer head 36 which adds graphic information to the linerless label material 28′. The linerless label material 28′ preferably has an adhesive on at least its lower side. Individual labels 26″ on a carrier web 38 on the second roll 24 are separated from the carrier web 38. The empty carrier web 38 is then rolled onto a carrier web roll 42. The linerless label material 28′, the labels 26″ and a separate liner 32′ are combined by the driven roller means 34 to form a combined web material 50 which then passes a programming station 60 and receives additional information. The combined web material 50 then passes a control station 62 which controls the functioning of the labels 26″ with electromagnetic wave information thereon. The combined web material 50 finally passes a terminal severing means 30 which cuts the combined web material 50 into suitable lengths of electromagnetic wave information-containing labels/graphic labels.

In an alternative embodiment (not shown), the linerless label material 28′ and the labels 26″ may be combined by the driven roller means 34. A separate liner 32′ may be combined with the already combined linerless label material 28′ and labels 26″ by a driven feeder roller 66 to form a combined web material 50 which then passes a programming station 60, a control station 62 and a terminal severing means 30 as described above.

The present invention makes it possible to print graphic material over the entire label surface since the labels with electromagnetic wave information thereon, e.g., alarm tags, chips or the like (which otherwise constitutes an uneven surface), are added after the printing. Further, it is possible to be selective in applying alarm tags, chips or other types of labels with electromagnetic wave information thereon to label material to form individual labels. For example, labels with electromagnetic wave information thereon may be added to the label material such that only a predetermined number of individual labels, for example, every second, fifth or tenth individual label, may be provided with a label with electromagnetic wave information thereon. This will aid in keeping costs down and still create unsurity among potential shoplifters since they will not know which individual labels have alarm tags or other labels with electromagnetic wave information thereon.

While the above embodiments of the label feeder 20 are preferred, the components of the label feeder 20 may be in any suitable arrangement.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. An apparatus for making labels comprising:
means for feeding a label material having a low adhesion material on a first side and a self-adhesive material on a second side;
means for printing graphic information on said label material;
means for feeding a plurality of labels with electromagnetic wave information thereon;
first means for combining said label material at said self-adhesive material on said second side against said plurality of labels thereby transferring said plurality of labels to said self-adhesive material on said second side of said label material to provide a combined material;
a sender of digital information via electromagnetic waves for emitting said waves to said plurality of labels with electromagnetic wave information, wherein said sender is positioned to act on said plurality of labels after said first means for combining; and
first means for severing said combined material into suitable lengths to form individual labels;
wherein said means for printing is positioned to act on said label material prior to said first means for combining.

2. The apparatus according to claim 1, further comprising a receiver which controls via electromagnetic waves functioning of said plurality of labels with electromagnetic wave information.

3. The apparatus according to claim 1, further comprising a second means for severing, wherein said second means for severing is constructed and arranged to cut a continuous web of labels into said plurality of labels with electromagnetic wave information before said first means for combining provides said combined material.

4. The apparatus according to claim 1, wherein said plurality of labels with electromagnetic wave information are stamped self-adhesive labels with electromagnetic wave information on a low-adhesive treated carrier web, wherein said plurality of labels are separated from said carrier web prior to or at said first means for combining, and further comprising a means for rolling said carrier web into a roll after said first means for combining provides said combined material.

5. The apparatus according to claim 1, further comprising a means for applying adhesive on said label material.

6. The apparatus according to claim 4, further comprising means for applying said low-adhesive on said carrier web.

7. The apparatus according to claim 1, wherein said label material is a linerless label material.

8. The apparatus according to claim 1, wherein said label material is a liner label material.

9. The apparatus according to claim 8, further comprising a means for separating a liner from said label material of said liner label material, wherein said means for separating is positioned to separate said liner from said label material before said first means for combining.

10. The apparatus according to claim 9, wherein said liner is combined with said label material and said plurality of labels by said first means for combining to form said combined material, wherein said plurality of labels are positioned between said label material and said liner in said combined material.

11. The apparatus according to claim 9, wherein said label material and said plurality of labels are combined by said first means for combining, wherein said liner is thereafter combined with said label material and said plurality of labels by a second means for combining.

12. The apparatus according to claim 1, further comprising a means for feeding a liner, wherein a liner is combined with said label material and said plurality of labels by said first means for combining, wherein said plurality of labels are positioned between said label material and said liner.

13. The apparatus according to claim 1, further comprising a means for feeding a liner, wherein a liner is combined with said label material and said plurality of labels after said first means for combining by a second means for combining.

14. The apparatus according to claim 1, wherein said plurality of labels with electromagnetic wave information thereon are fed and combined with said label material such that only a predetermined number, which is less than all, of said individual labels have one of said plurality of labels with electromagnetic wave information thereon.

15. A method for making labels comprising:
feeding a label material having a low adhesion material on a first side and a self-adhesive material on a second side;
printing graphic information on said label material;
feeding a plurality of labels with electromagnetic wave information thereon;
combining said label material at said self-adhesive material on said second side against said plurality of labels thereby transferring said plurality of labels to said self-adhesive material on said second side of said label material to provide a combined material;
sending digital information via electromagnetic waves for emitting said waves to said plurality of labels with electromagnetic wave information and thereby programming said plurality of labels after said combining; and
severing said combined material into suitable lengths to form individual labels;
wherein said printing occurs on said label material prior to combining said label material with said plurality of labels.

16. The method according to claim 15, further comprising controlling a functioning of said plurality of labels with electromagnetic wave information via electromagnetic waves.

17. The method according to claim 15, further comprising severing a continuous web of labels into said plurality of labels with electromagnetic wave information before said combining provides said combined material.

18. The method according to claim 15, wherein said plurality of labels with electromagnetic wave information are stamped self-adhesive labels with electromagnetic wave information on a low-adhesive treated carrier web, wherein said plurality of labels are separated from said carrier web prior to or during said combining and further comprising rolling said carrier web into a roll after said means for combining provides said combined material.

19. The method according to claim 15, further comprising applying adhesive on said label material.

20. The method according to claim 18, further comprising applying said low-adhesive on said carrier web.

21. The method according to claim 15, wherein said label material is a linerless label material.

22. The method according to claim 15, wherein said label material is a liner label material.

23. The method according to claim 22, further comprising separating a liner from said label material of said liner label material before said combining.

24. The method according to claim 23, wherein said liner is combined with said label material and said plurality of labels to form said combined material during said combining, wherein said plurality of labels are positioned between said label material and said liner in said combined material.

25. The method according to claim 23, further comprising secondarily combining said liner with said label material and said plurality of labels after said combining of said label material and said plurality of labels.

26. The method according to claim 15, further comprising feeding a liner from a separate feeding means and combining said liner with said label material and said plurality of labels during said combining, wherein said plurality of labels are positioned between said label material and said liner.

27. The method according to claim 15, further comprising feeding a liner from a separate feeding means and secondarily combining said liner with said label material and said plurality of labels after said combining of said label material and said plurality of labels, wherein said plurality of labels are positioned between said label material and said liner.

28. The method according to claim 15, further comprising preprinting said label material with color or graphic information.

29. The method according to claim 15, wherein said feeding said plurality of labels and said combining said label material against said plurality of labels occurs such that only a predetermined number, which is less than all, of said individual labels have one of said plurality of labels with electromagnetic wave information thereon.
